(19) United States
(12) Patent Application Publication
(10) Pub. No.: US 2007/0265078 A1
(43) Pub. Date: Nov. 15, 2007

(54) Steering wheel control assembly with speedy control key(s)

(76) Inventor: Alvin Yu, Yong He City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/430,001

(22) Filed: May 9, 2006

(51) Int. Cl. A63F 13/00

(52) U.S. Cl. 463/37

(57) ABSTRACT

A steering wheel control assembly with speedy control key(s) is disclosed. The steering wheel control assembly of the present invention includes a steering wheel, at least a speedy control key, a base unit and a connector. Either speedy control key is disposed on the right side or the left side of the upper surface of the steering wheel. The functions of either speedy control key may be set through software or hardware. The steering wheel control assembly of the present invention can allow a user to play a video game with only one hand so that he can use his other hand to do other things.

### BACKGROUND OF THE INVENTION

1. Field of the Invention

The invention relates to a steering wheel control assembly that includes a steering wheel and at least a speedy control key, which is disposed on the right side or the left side of the upper surface of the steering wheel and whose functions may be set through software or hardware. The steering wheel control assembly of the present invention can allow a user to play a video game with only one hand so that he can use his other hand to do other things.

2. Description of the Prior Art

There are various types of video/computer games, and each type of video/computer game has its own features and loyal players. Suitable software and hardware are needed so that we can enjoy a certain type of video/computer game. With regard to a car racing game, the use of a regular control device (such as keyboard, mouse or a regular game control device) is not suitable. In fact, a steering wheel is a preferred choice for a car racing game, and there is no reason not to use a steering wheel for a car racing game. A well designed steering wheel may make a car racing game more enjoyable.

It is quite important that a steering wheel control assembly has an ergonomic design; otherwise, the use of a poorly designed steering wheel control assembly for a short period would cause fatigue to a user. An ergonomically designed control device allows a user to use it comfortably and easily. Also, the steering wheel control assembly of the prior art has a pedal unit so as to provide the functions of acceleration and braking. In the steering wheel control assembly of the present invention, the functions of acceleration and braking are provided by at least one speedy control key disposed on the steering wheel; hence, the cost of production may be lowered.

Many control devices available from the market are provided with several control keys. As illustrated in FIG. 1, though the control keys can provide several functions, these control keys are rarely used and hence are quite unpopular with the players, especially for a car racking game, because the use of them takes too much effort or they are too difficult to use.

To a player of a video game, he usually aims to surpass the highest point. He may have to use one of his hands to do other thing (for example, he has to answer the phone) in the middle of the game. If this happens when a steering wheel control assembly of the prior art is used, his game must be interrupted. In contrast, when the steering wheel control assembly of the present invention is used, he may have one of his hands free to do other things and hence his game may be kept from interruption.

To eliminate the disadvantages of the steering wheel control assembly of the prior art, the inventor has put in a lot of effort in the subject and has successfully come up with the steering wheel control assembly with speedy control key(s) of the present invention.

### SUMMARY OF THE INVENTION

An object of the present invention is to provide a steering wheel control assembly with speedy control key(s) that is disposed on the steering wheel so that a user's hand may easily reach and whose functions may be set through software or hardware.

Another object of the present invention is to provide a steering wheel control assembly with speedy control key(s) that may be used with one hand so that a user can use his other hand to do other things.

The steering wheel control assembly with speedy control key(s) of the present invention comprises a steering wheel, two speedy control keys, a base unit and a connector. The two speedy control keys are disposed on the right side and the left side, respectively, of the upper surface of the steering wheel. Either speedy control key may be of track type, and the functions of either speedy control key may be set through software or hardware. The steering wheel control assembly of the prior art has a pedal unit so as to provide the functions of acceleration and braking. In the steering wheel control assembly of the present invention, two speedy control keys are disposed on the steering wheel and either speedy control key has the functions of acceleration, braking and gear-shifting. Hence, the cost of production may be lowered. Either speedy control key may be of track type or roller type. For example, if a speedy control key is of track type, the forward movement of the speedy control key may correspond to acceleration; the rearward movement of it may correspond to braking; the downward movement of the speedy control key may correspond to gear-shifting. Also, either speedy control key may return to its former position automatically after a forward movement, a rearward movement or a downward movement. With the steering wheel control assembly of the present invention, a user only has to use one hand to play a video game and has his other hand free to do other things. The base unit is disposed under the steering wheel, and the connector extends out of the base unit and may connect the steering wheel control assembly of the present invention with a computer or a video game machine. The functions of the three types of movements of either speedy control key may be set according to the unique characteristics of a certain type of game. Also, the steering wheel control assembly of the present invention has an ergonomic design.

### BRIEF DESCRIPTION OF THE DRAWINGS

The drawings disclose an illustrative embodiment of the present invention which serves to exemplify the various advantages and objects hereof, and are as follows:

FIG. 1 is a view schematically illustrating the steering wheel control assembly of the prior art.

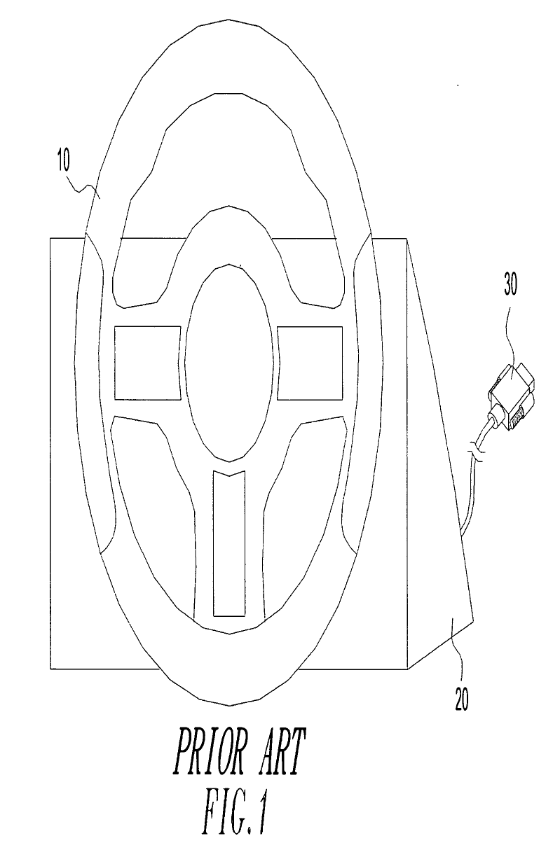

FIG. 2 is a view schematically illustrating the steering wheel control assembly of the present invention.

### LIST OF REFERENCE NUMERALS

| | | | |
|---|---|---|---|
| 10 | Steering wheel | 11 | Speedy control key(s) |
| 20 | Base unit | 30 | Connector |

### DETAILED DESCRIPTION OF THE PREFERRED EMBODIMENT

The present invention may become more understandable if the following description is read with reference to the drawings.

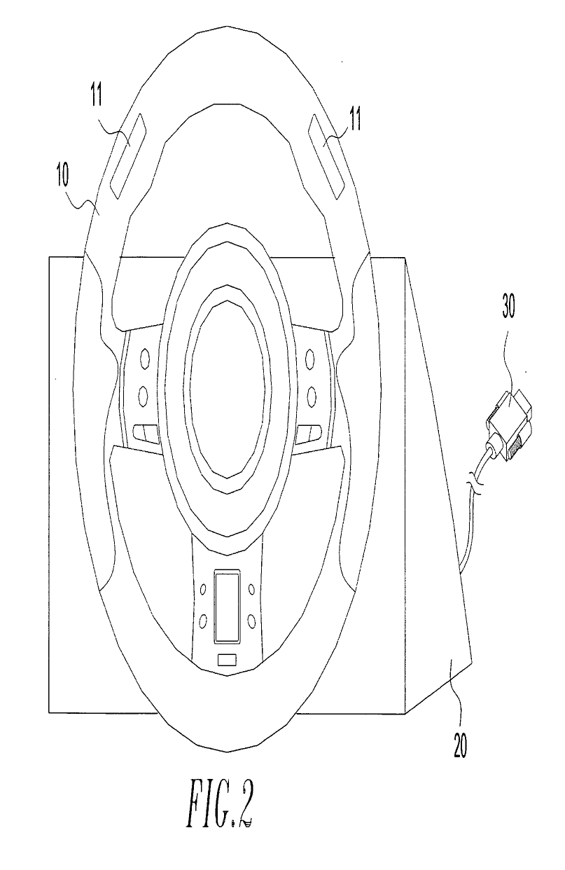

As illustrated in FIG. 2, the steering wheel control assembly of the present invention comprises a steering wheel 10, at least a speedy control key 11, a base unit 20 and a connector 30. Each speedy control key 11 is disposed on the right side or the left side of the upper surface of the steering wheel 10. Each speedy control key 11 may be of roller type or track type and may be moved forwards, rearwards and downwards. The function of each type of movement of each speedy control key 11 may be set through hardware or software. The functions so set or programmed may be stored in the steering wheel 10. For example, the forward movement of a speedy control key 11 corresponds to acceleration; the rearward movement of a speedy control key 11 corresponds to deceleration or braking; the downward movement of a speedy control key 11 (when the key 11 is being pressed) corresponds to gear-shifting. The speedy control key 11 may return to its former position automatically after a forward movement, a rearward movement or a downward movement. With the steering wheel control assembly of the present invention, a user only has to use one hand to play a video game. Of course, he may use both of his hands; in this case, a video game may become more enjoyable. The base unit 20 is disposed under the steering wheel 10, and the connector 30 extends out of the base unit 20. The connector 30 may connect the steering wheel control assembly of the present invention with a computer or a video game machine. The connector 30 may be an ordinary connector in the forms of USB, IEEE1394, RS232, various types of game platforms or other forms. Also, the connector 30 may be of wireless connection in the forms of WI-Fl, Bluetooth, RF, infrared, various types of wireless game platforms or other wireless forms. The functions of the three types of movements of each speedy control key 11 may be set according to the unique characteristics of a certain type of game. Also, the steering wheel control assembly of the present invention has an ergonomic design.

In conclusion, the present invention provides a steering wheel control assembly with track type speedy control key(s), whose functions may be set. Also, each speedy control key may return to its former position automatically after a forward movement, a rearward movement or a downward movement. The steering wheel control assembly of the present invention has an ergonomic design, and its cost of production may be lowered. In addition, the functions of each speedy control key may be set or programmed through software or hardware according to the unique characteristics of a certain type of game. From the above, we can see that the steering wheel control assembly of the present invention meets the relevant patent requirements. It is hoped that the patent application will be approved.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A steering wheel control assembly with speedy control key(s), comprising:
a steering wheel;
at least a speedy control key, characterized in that at least one speedy control key having a plurality of functions is disposed on the steering wheel so that a user's hand may reach easily;
a base unit; and
a connector.

2. The steering wheel control assembly with speedy control key(s) as in claim 1, wherein one speedy control key is disposed on the right side of the upper surface of the steering wheel and the other speedy control key is disposed on the left side of the upper surface of the steering wheel, and wherein either speedy control key may be set with different functions.

3. The steering wheel control assembly with speedy control key(s) as in claim 1, wherein the functions of either speedy control key may be set through software.

4. The steering wheel control assembly with speedy control key(s) as in claim 1, wherein the functions of either speedy control key may be set through hardware.

5. The steering wheel control assembly with speedy control key(s) as in claim 1, wherein either speedy control key is of track type and may be moved forwards, rearwards and downwards, and wherein each of the three types of the movements of either speedy control key corresponds to a specific function.

6. The steering wheel control assembly with speedy control key(s) as in claim 1, wherein either speedy control key is of roller type and may be moved forwards, rearwards and downwards, and wherein each of the three types of the movements of either speedy control key corresponds to a specific function.

7. The steering wheel control assembly with speedy control key(s) as in claim 1, wherein each speedy control key may return to its former position automatically after a forward movement, a rearward movement or a downward movement.

8. The steering wheel control assembly with speedy control key(s) as in claim 1, wherein the steering wheel control assembly of the present invention has at least a connector.

9. The steering wheel control assembly with speedy control key(s) as in claim 8, wherein the connector may connect the steering wheel control assembly of the present invention with a computer or a video game machine, and the connector may be an ordinary connector in the forms of USB, IEEE1394, RS232 or other forms.

10. The steering wheel control assembly with speedy control key(s) as in claim 8, wherein the connector may be of wireless connection in the forms of WI-FL, Bluetooth, RF, infrared or other wireless forms.
